(19) United States
(12) Patent Application Publication
(10) Pub. No.: US 2021/0002161 A1
(43) Pub. Date: Jan. 7, 2021

(54) METHOD OF MOLDING OPTICAL ELEMENT AND OPTICAL ELEMENT MOLDING MOLD

(71) Applicant: OLYMPUS CORPORATION, Tokyo (JP)

(72) Inventor: Kenji KIKUCHI, Tokyo (JP)

(73) Assignee: OLYMPUS CORPORATION, Tokyo (JP)

(21) Appl. No.: 17/026,358

(22) Filed: Sep. 21, 2020

Related U.S. Application Data
(63) Continuation of application No. PCT/JP2019/010011, filed on Mar. 12, 2019.

(30) Foreign Application Priority Data
Mar. 30, 2018 (JP) 2018-069225

(51) Int. Cl. C03B 11/08

(52) U.S. Cl. CPC C03B 11/08; C03B 2215/65; C03B 2215/50; C03B 2215/46

(57) ABSTRACT

A method of molding an optical element includes: preparing a molding material; preparing an upper mold having an upper surface molding surface, a lower mold having a lower surface molding surface, and a side mold having a side surface molding surface; inserting a neck portion of the upper mold and a neck portion of the lower mold into a hole portion of the side mold; positioning a distal end of the neck portion of the lower mold below an opening rim of the hole portion, and electing oxygen that is in the molds through a gap formed between the opening rim of the hole portion and the molding material that has been placed on the lower surface molding surface; heating up the molding material; and press molding the molding material by bringing the upper mold and side mold, and the lower mold, closer to each other.

This application is a continuation of PCT international application Ser. No. PCT/JP2019/010011 filed on Mar. 12, 2019 which designates the United States, incorporated herein by reference, and which claims the benefit of priority from Japanese Patent Applications No. 2018-069225, filed on Mar. 30, 2018, incorporated herein by reference.

### BACKGROUND

The present disclosure relates to a method of molding an optical element and optical element molding molds.

A molding method, in which a glass material that is a molding material is heated and press molded by means of molds to transfer forms of the molds to the glass material, as disclosed in JP2003292327A, for example, has been known as one method of molding an optical element, such as a glass lens. This molding method for an optical element enables the cost including that for any downstream process to be reduced, by molding of, in addition to optically functional surfaces provided on upper and lower surfaces of the optical element, a side surface of the optical element, together at once.

### SUMMARY

According to one aspect of the present disclosure, there is provided a method of molding an optical element, the method including: preparing a molding material; preparing: an upper mold having an upper surface molding surface provided on an end portion of a neck portion of the upper mold; a lower mold having a lower surface molding surface provided on an end portion of a neck portion of the lower mold; and a side mold having a side surface molding surface provided on an inner surface of a hole portion of the side mold; inserting the neck portion provided in the upper mold and the neck portion provided in the lower mold into the hole portion provided in the side mold; positioning a distal end of the neck portion of the lower mold below an opening rim of the hole portion of the side mold, and ejecting oxygen that is in the molds through a gap formed between the opening rim of the hole portion of the side mold and the molding material that has been placed on the lower surface molding surface; heating up the molding material; and press molding the molding material by bringing the upper mold and side mold, and the lower mold, closer to each other.

According to another aspect of the present disclosure, there is provided an optical element molding mold including: an upper mold having a neck portion; a lower mold having a neck portion; a side mold having, provided therein, a hole portion where the neck portions of the upper mold and the lower mold are inserted; an upper surface molding surface provided on an end portion of the neck portion of the upper mold; a lower surface molding surface provided on an end portion of the neck portion of the lower mold; and a side surface molding surface provided on an inner surface of the hole portion of the side mold, wherein at a first position where a gap between a distal end of the neck portion of the lower mold and an opening rim of the side mold becomes the largest, before or after a molding operation in a state where the optical element molding mold has been fitted in a molding machine, the gap is smaller than a thickness of a molding material that has been placed on the lower surface molding surface.

According to still another aspect of the present disclosure, there is provided an optical element molding mold including: an upper mold having a neck portion; a lower mold having a neck portion; a side mold having, provided therein, a hole portion where the neck portions of the upper mold and the lower mold are inserted; an upper surface molding surface provided on an end portion of the neck portion of the upper mold; a lower surface molding surface provided on an end portion of the neck portion of the lower mold; and a side surface molding surface provided on an inner surface of the hole portion of the side mold, wherein at a first position where a gap between a distal end of the neck portion of the lower mold and an opening rim of the side mold becomes the largest, before or after a molding operation in a state where the optical element molding mold has been fitted in a molding machine, the gap is smaller than a side surface thickness of an optical element.

The above and other features, advantages and technical and industrial significance of this disclosure will be better understood by reading the following detailed description of the disclosure, when considered in connection with the accompanying drawings.

### BRIEF DESCRIPTION OF THE DRAWINGS

FIG. 1 is a sectional view illustrating a configuration of main parts of a molding apparatus including an optical element molding mold according to a first embodiment;

FIG. 2 is a sectional view illustrating a configuration of the optical element molding mold according to the first embodiment;

FIG. 3 is an enlarged diagram of a part of the optical element molding mold according to the first embodiment;

FIG. 4 is a flow chart illustrating a method of molding an optical element using the optical element molding mold according to the first embodiment;

FIG. 5 is a diagram illustrating a state of the optical element molding mold in a press molding process in the method of molding an optical element, according to the first embodiment;

FIG. 6 is a diagram illustrating a state of the optical element molding mold in a demolding process in the method of molding an optical element, according to the first embodiment;

FIG. 7 is a diagram illustrating a state of an optical element molding mold in an oxygen ejecting process in a method of molding an optical element, according to a second embodiment;

FIG. 8 is a diagram illustrating a state of the optical element molding mold in the oxygen ejecting process in the method of molding an optical element, according to the second embodiment; and

FIG. 9 is a diagram illustrating a state of an optical element molding mold in a pressing process in a method of molding an optical element, according to a third embodiment.

### DETAILED DESCRIPTION

Embodiments of a method of molding an optical element and an optical element molding mold, according to the present disclosure will be described below while reference is made to the drawings. The present disclosure is not limited to the following embodiments, and components in the following embodiments include any component that is easily substitutable by a person skilled in the art, or any component that is substantially the same.

### Configuration of Molding Apparatus

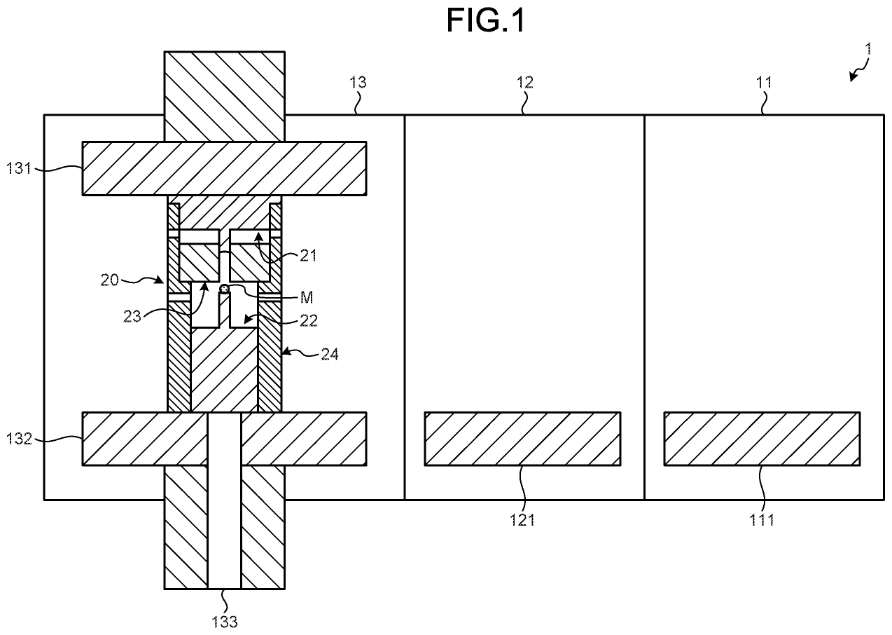

A molding apparatus 1 molds an optical element, for example, a glass lens, by press molding a molding material (for example, a glass material) M that has been softened by heating. The molding apparatus 1 mainly includes, as illustrated in FIG. 1, a mold supply unit 11, an oxygen ejecting unit 12, and a molding unit 13.

At the mold supply unit 11, a mold supplying process of supplying a mold 20 before molding to the molding apparatus 1, and a mold ejecting process of ejecting the mold 20 after the molding from the molding apparatus 1, are performed. The mold supply unit 11 has, provided therein, a placement unit 111 for placement of the mold 20 that has been conveyed by a conveying mechanism not illustrated in the drawings.

At the oxygen electing unit 12, an oxygen ejecting process of ejecting oxygen that is inside the mold 20 to replace the atmosphere inside the mold 20 with inert gas, such as nitrogen, is performed. The oxygen electing unit 12 has, provided therein, a placement unit 121 for placement of the mold 20 that has been conveyed by a conveying mechanism not illustrated in the drawings.

At the molding unit 13, a heating process, a press molding process, and a cooling process, are performed. The molding unit 13 has, provided therein, an upper plate 131 and a lower plate 132 that are for heating and pressing the mold 20, with the mold 20 interposed between the upper plate 131 and the lower plate 132, the mold 20 having been conveyed by a conveying mechanism not illustrated in the drawings. Each of the upper plate 131 and the lower plate 132 has, provided therein, a heating mechanism and a cooling mechanism, which are not illustrated in the drawings. Furthermore, the lower plate 132, has, provided therein, a pressing mechanism (a pressing pin) 133 for pressing a lower mold 22 in the press molding process.

### Configuration of Mold

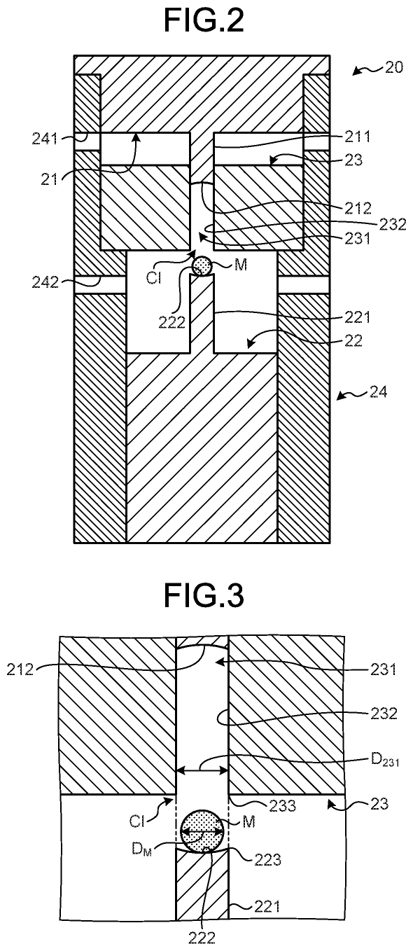

A configuration of the mold (an optical element molding mold) 20 according to an embodiment will be described while reference is made to FIG. 2 and FIG. 3. The mold 20 includes, as illustrated in FIG. 2, an upper mold, the lower mold 22, a side mold 23, and a sleeve 24.

An upper mold 21 includes a neck portion 211 that extends toward the lower mold 22, the neck portion 211 being columnar. This neck portion 211 of the upper mold 21 is a portion to be inserted into a hole portion 231 of the side mold 23. An end portion of the neck portion 211 has, provided thereon, an upper surface molding surface 212 for molding an optically functional upper surface of an optical element.

The lower mold 22 includes a neck portion 221 that extends toward the upper mold 21, the neck portion 221 being columnar. This neck portion 221 of the lower mold 22 is a portion to be inserted into the hole portion 231 of the side mold 23. An end portion of the neck portion 221 has, provided thereon, a lower surface molding surface 222 for molding an optically functional lower surface of an optical element.

The lower mold 22 is configured to, as described later, enable a distal end of the neck portion 221 of the lower mold 22 to be positioned at a position (hereinafter, referred to as a “first position”) lower than an opening rim 233 of the hole portion 231 of the side mold 23. The “distal end of the neck portion 221 of the lower mold 22” specifically means an outer peripheral rim 223 at a distal end of the neck portion 221 of the lower mold 22 illustrated in FIG. 3.

The side mold 23 has, provided therein, the hole portion 231 vertically penetrating the side mold 23. An inner surface of this hole portion 231 has, provided thereon, a side surface molding surface 232 for molding a side surface of an optical element. The upper mold 21 and the lower mold 22 are disposed at positions where their molding surfaces face each other, with the side mold 23 interposed between the upper mold 21 and the lower mold 22. Furthermore, the upper mold 21, the lower mold 22, and the side mold 23 are disposed inside the sleeve 24.

The sleeve 24 is for housing therein the upper mold 21, the lower mold 22, and the side mold 23. The sleeve 24 has a cylindrical shape. Furthermore, the sleeve 24 has, formed therein, vents 241 and 242, through which the interior and the exterior of the sleeve 24 communicate, and which are for introducing inert gas into the mold 20 in an oxygen ejecting process of a later described method of molding an optical element.

### Assembling Process for Mold

An assembling process for the mold 20 before molding be described below. Firstly, the lower mold 22 and the side mold 23 are fitted in the sleeve 24.

Specifically, the side mold 23 is disposed on a stepped portion provided inside the sleeve 24, and the lower mold 22 is disposed such that a lower end surface of the lower mold 22 becomes coplanar with a lower end surface of the sleeve 24. As illustrated in FIG. 3, the outer peripheral rim 223 of the neck portion 221 of the lower mold 22 is positioned at the first position lower than the opening rim 233 of the hole portion 231 of the side mold 23, and a predetermined clearance Cl is thereby formed between the outer peripheral rim 223 of the neck portion 221 of the lower mold 22 and the opening rim 233 of the hole portion 231 of the side mold 23.

Subsequently, a molding material M is placed on the lower surface molding surface 222 of the lower mold 22. FIG. 3 illustrates a molding material M that is spherical as an example, but the molding material M is not necessarily spherical and may have, for example, an approximately spherical pellet shape or a lens shape that has been processed to be approximately spherical beforehand.

The molding material M may be placed as follows. For example, before the molding material M is placed on the lower surface molding surface 222, the lower mold 22 is lifted up to a position (a position higher than the first position) where the outer peripheral rim 223 of the lower surface molding surface 222 is higher than the opening rim 233 of the side mold 23. After the molding material M has been placed on the lower surface molding surface 222 at that position, the lower mold 22 is lowered to the first position. As a result, the distance by which the molding material M is inserted into the hole portion 231 of the side mold 23 is shortened and placement of the molding material M is thus facilitated.

If the distance by which the molding material M is inserted into the hole portion 231 of the side mold 23 is long, for example, when a spherical molding material M is released from suction by a jig, which conveys the molding material M, and is dropped, the molding material M may bounce and jump out of the hole portion 231. Furthermore, if the distance by which the molding material M is inserted into the hole portion 231 of the side mold 23 is long, for example, when a lens shaped molding material M that has been processed approximately spherical is released from suction by a jig, which conveys the molding material M, and is dropped, the molding material M may rotate in the hole portion 231 and be in a wrong posture, for example, upside down.

As described above, by placing a molding material M after lifting the lower mold 22 to a position where the outer peripheral rim 223 of the lower surface molding surface 222 is higher than the opening rim 233 of the side mold 23, the molding material M is able to be prevented from lumping out or rotating.

Furthermore, the molding material M has been processed to have a diameter D_{M} smaller than an inner diameter D₂₃₁ of the hole portion 231 for the purpose of enabling press molding by the upper mold 21 and the lower mold 22 inside the hole portion 231 of the side mold 23. As a result, when the molding material M is inserted in the hole portion 231, a predetermined clearance is formed between the molding material M and the inner surface (the side surface molding surface 232) of the hole portion 231.

Subsequently, the upper mold 21 is fitted in the sleeve 24. Specifically, the upper mold 21 is placed on an upper end surface of the sleeve 24, and the neck portion 211 of the upper mold 21 is inserted in the hole portion 231 of the side mold 23.

The neck portion 221 of the lower mold 22 has been formed to be equal in length to or larger in length than the hole portion 231 of the side mold 23. Being “equal” includes a state where the length of the neck portion 221 of the lower mold 22 is the same as the length of the hole portion 231 of the side mold 23, a state where the length of the neck portion 221 of the lower mold 22 is minutely shorter than the length of the hole portion 231 of the side mold 23, and a state where the length of the neck portion 221 of the lower mold 22 is minutely longer than the length of the hole portion 231 of the side mold 23.

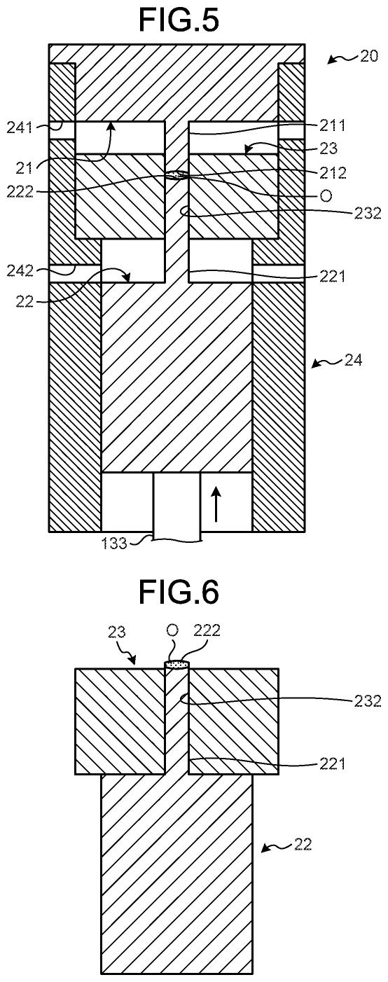

As a result, in a demolding process in a later described method of molding an optical element, lifting the lower mold 22 relatively to the side mold 23 in a state where the upper mold 21 has been removed (see FIG. 6) raises the lower surface molding surface 222 to be positioned above a position where the lower surface molding surface 222 is positioned at the time of press molding (see FIG. 5). The outer peripheral rim 223 of the neck portion 221 of the lower mold 22 is then raised to a height that is substantially the same as that of an upper opening rim of the hole portion 231 of the side mold 23, or to a position higher than that of the upper opening rim of the hole portion 231 of the side mold 23.

### Method of Molding Optical Element

A first embodiment of a method of molding an optical element using the mold 20 will be described below while reference is made to FIG. 1 to FIG. 6. The method of molding an optical element according to the first embodiment includes: inserting the neck portion 211 provided in the upper mold 21 and the neck portion 221 provided in the lower mold 22, into the hole portion 231 provided in the side mold 23; and thereafter molding an optical element from a molding material M by means of the upper surface molding surface 212 provided on the upper mold 21, the lower surface molding surface 222 provided on the lower mold 22, and the side surface molding surface 232 provided on the side mold 23.

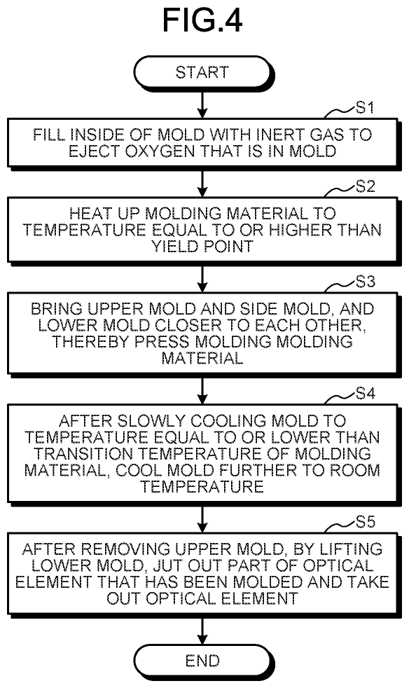

In the method of molding an optical element, an oxygen ejecting process is performed at the oxygen ejecting unit 12, after the mold 20 (see FIG. 2) before molding that has been assembled outside the molding apparatus 1 is supplied to the mold supply unit 11 of the molding apparatus 1. After a heating process, a press molding process, and a cooling process have been performed at the molding unit 13, the mold 20 after molding is ejected from the mold supply unit 11, and a demolding process is performed outside the molding apparatus 1. Conveyance between the mold supply unit 11, the oxygen ejecting unit 12, and the molding unit 13 is performed by a conveying mechanism not illustrated in the drawings (for example, an arm). Each of these processes will be described specifically below while reference is made to FIG. 4 to FIG. 6.

### Oxygen Ejecting Process

In the oxygen ejecting process, the inside of the mold 20 conveyed to the oxygen ejecting unit 12 is filled with inert gas, such as nitrogen, to eject the oxygen that is in the mold 20 (Step S1). In the oxygen electing process, specifically, in a state where the outer peripheral rim 223 of the neck portion 221 of the lower mold 22 has been positioned at the first position lower than the opening rim 233 of the hole portion 231 of the side mold 23, the oxygen that is in the mold 20 is ejected through the clearance Cl formed between the opening rim 233 of the hole portion 231 of the side mold 23 and the molding material M that has been placed on the lower surface molding surface 222. Setting of the positional relation where the outer peripheral rim 223 of the neck portion 221 of the lower mold 22 is positioned at the first position is performed in the above described assembling process for the mold 20.

In the oxygen ejecting process, more specifically, the oxygen that is inside the mold 20 is ejected through: the vents 241 and 242 formed in the sleeve 24; and the clearance Cl formed between the opening rim 233 of the hole portion 231 of the side mold 23 and the molding material M that has been placed on the lower surface molding surface 222, and the atmosphere inside the mold 20 is replaced with the inert gas. To ensure the replacement with the inert gas in the oxygen ejecting process, the atmosphere in the oxygen ejecting unit 12 may be decompressed by a vacuum pump not illustrated in the drawings, and the inside of the mold 20 may thereafter be filled with the inert gas.

### Heating Process

In the heating process, the mold 20 that has been conveyed to the molding unit 13 is interposed between the upper plate 131 and the lower plate 132, and the molding material M is heated up to a temperature equal to or higher than a yield point of the molding material M (Step S2).

### Press Molding Process

In the press molding process, the upper mold 21 and side mold 23, and the lower mold 22 are brought closer to each other, and the molding material M is thereby press molded (Step S3). In the press molding process, specifically, as illustrated in FIG. 5, the pressing mechanism 133 of the molding apparatus 1 is lifted, thereby lifting the lower mold 22 and the molding material M and inserting the neck portion 221 of the lower mold 22 into the hole portion 231 of the side mold 23. As a result, inside the hole portion 231 of the side mold 23, optically functional upper and lower surfaces of an optical element O are transferred by the upper surface molding surface 212 and the lower surface molding surface 222 and a side surface of the optical element O is transferred by the side surface molding surface 232.

### Cooling Process

In the cooling process, after slowly cooling the mold 20 to a temperature equal to or lower than a transition temperature of the molding material M, the mold 20 is further cooled to a room temperature (Step S4).

### Demolding Process

In the demolding process, after the upper mold 21 has been removed from the side mold 23, by lifting the lower mold 22 by means of the pressing mechanism 133 as illustrated in FIG. 6, a part of the optical element O that has been molded is jutted out from an upper end portion of the side mold 23 and the optical element O is taken out (Step S5). In the demolding process, the optical element O that has been jutted out from the upper end portion of the side mold 23 as illustrated in FIG. 6 is taken out by sucking the optical element O using a suction jig, for example.

The above described method of molding the optical element O enables the oxygen in the mold 20 to be elected and replaced with the inert gas, through the clearance Cl formed between the opening rim 233 of the hole portion 231 of the side mold 23 and the molding material M that has been placed on the lower surface molding surface 222, as illustrated in FIG. 3, even in the state where the neck portion 211 of the upper mold 21 has been inserted in the hole portion 231 of the side mold 23 beforehand. Furthermore, according to the method of molding the optical element O, just the simple configuration, in which the lower mold 22 is driven with the upper mold 21 and the side mold 23 placed in the sleeve 24 and kept fixed therein, enables the oxygen inside the mold 20 to be ejected and replaced with the inert gas and the optically functional surfaces and the side surface of the optical element O to be molded together at once.

### Method of Molding Optical Element

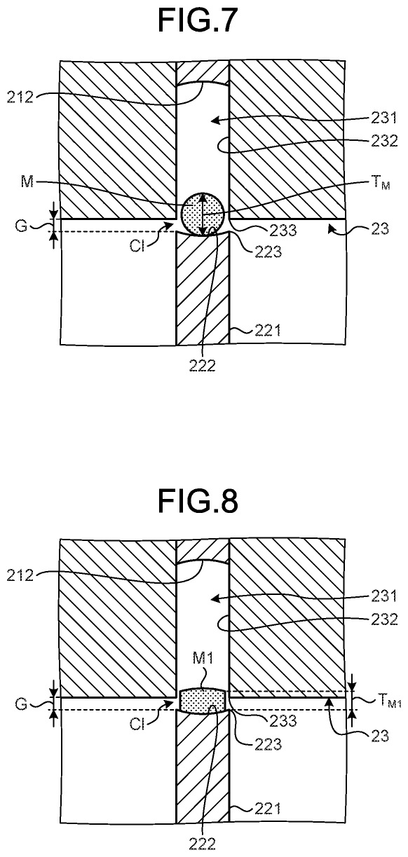

A second embodiment of the method of molding an optical element O using the mold 20 will be described below while reference is made to FIG. 7 and FIG. 8. In this second embodiment, the molding apparatus 1 is used in common with the first embodiment. However, according to the second embodiment, the positional relation between the side mold 23 and the lower mold 22 in the mold 20 is different from that according to the first embodiment. Firstly, an assembling process for the mold 20 according to the second embodiment will be described below.

Similarly to the first embodiment, in the assembling process for the mold 20 according to the second embodiment, the lower mold 22 is disposed such that the lower end surface of the lower mold 22 becomes coplanar with the lower end surface of the sleeve 24. As illustrated in FIG. 7, the outer peripheral rim 223 of the neck portion 221 of the lower mold 22 is positioned at a first position lower than the opening rim 233 of the hole portion 231 of the side mold 23, and a predetermined clearance Cl is thereby formed between the outer peripheral rim 223 of the neck portion 221 of the lower mold 22 and the opening rim 233 of the hole portion 231 of the side mold 23.

In the mold 20 according to the second embodiment, the clearance Cl is set to be smaller than a thickness T_{M} of a molding material M. That is, when viewed in the horizontal direction as illustrated in FIG. 7, the clearance Cl set such that a part of the molding material M is positioned above the opening rim 233 of the hole portion 231 of the side mold 23.

If the molding material M used is spherical as illustrated in FIG. 7, for example, the clearance Cl is set at a value smaller than a diameter of the spherical molding material M. Furthermore, as illustrated in FIG. 8, for example, if a lens-shaped molding material M1 having both of its upper and lower surfaces processed approximately spherically is used, the clearance Cl is set at a value smaller than a side surface thickness T_{M1} of the lens-shaped molding material M1 (an outermost peripheral portion thickness), the side surface thickness T_{M1} being a thickness of the lens-shaped molding material M1 at its side surface. Details of the method of molding an optical element O according to the second embodiment will be described below.

In this method of molding an optical element O according to the second embodiment, similarly to the first embodiment: the mold 20 assembled outside the molding apparatus 1 and before molding is supplied to the mold supply unit 11 of the molding apparatus 1; an oxygen ejecting process, a heating process, a press molding process, and a cooling process are performed; and a demolding process is thereafter performed outside the molding apparatus 1. The heating process, the press molding process, the cooling process, and the demolding process are similar to those according to the first embodiment and description thereof will thus be omitted.

In the oxygen ejecting process according to the second embodiment, as illustrated in FIG. 7 and FIG. 8, oxygen is ejected and replaced with inert gas, in a state where a gap G between the outer peripheral rim 223 of the neck portion 221 of the lower mold 22 and the opening rim 233 of the hole portion 231 of the side mold 23 is smaller than the thickness T_{M} of the molding material M (or the side surface thickness T_{M1} of the molding material M1) that has been placed on the lower surface molding surface 222 when the outer peripheral rim 223 of the neck portion 221 of the lower mold 22 is positioned below the first position lower than the opening rim 233 of the hole portion 231 of the side mold 23.

Furthermore, according to the second embodiment, this state, in which the gap G between the outer peripheral rim 223 of the neck portion 221 of the lower mold 22 and the opening rim 233 of the hole portion 231 of the side mold 23 is smaller than the thickness T_{M} of the molding material M (or the side surface thickness T_{M1} of the molding material M1) that has been placed on the lower surface molding surface 222, is maintained from the placement of the molding material N onto the lower surface molding surface 222 in the assembling process until the press molding process is started.

According to the method of molding an optical element O as described above, the gap G between the outer peripheral rim 223 of the neck portion 221 of the lower mold 22 and the opening rim 233 of the hole portion 231 of the side mold 23 is made smaller than the thickness T_{M} of the molding material M (or the side surface thickness T_{M1} of the molding material M1) that has been placed on the lower surface molding surface 222. Therefore, the molding material M is able to be prevented from falling off the lower surface molding surface 222 due to, for example: flow of gas generated when the oxygen is ejected to be replaced with inert gas; or minute vibration generated when the mold 20 is conveyed before press molding or when the lower mold 22 is lifted at the time of press molding. As a result, for example, the risk of performing press molding in a state where a molding material M is not on the lower surface molding surface 222 or a state where a molding material M juts out from the lower surface molding surface 222, and thereby damaging the mold 20, at the time of press molding, is able to be avoided.

### Method of Molding Optical Element

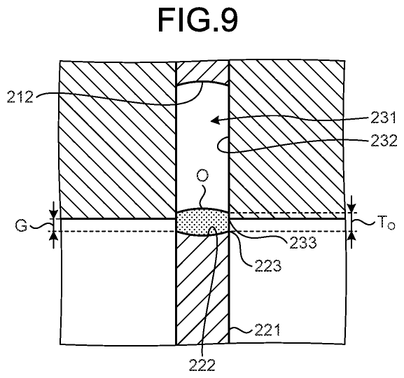

A third embodiment of the method of molding an optical element O using the mold 20 will be described below while reference is made to FIG. 9. According to the third embodiment, the molding apparatus 1 is used in common with the first embodiment. However, according to the third embodiment, the positional relation between the side mold 23 and the lower mold 22 in the mold 20 is different from that according to the first embodiment. Firstly, an assembling process for the mold 20 according to the third embodiment will be described below.

Similarly to the first embodiment, in the assembling process for the mold 20 according to the third embodiment, the lower mold 22 is disposed such that the lower end surface of the lower mold 22 becomes coplanar with the lower end surface of the sleeve 24. As illustrated in FIG. 9, the outer peripheral rim 223 of the neck portion 221 of the lower mold 22 is positioned at a first position lower than the opening rim 233 of the hole portion 231 of the side mold 23, and a predetermined clearance Cl is thereby formed between the outer peripheral rim 223 of the neck portion 221 of the lower mold 22 and the opening rim 233 of the hole portion 231 of the side mold 23.

In the mold 20 according to the third embodiment, this clearance Cl is made smaller than a side surface thickness T_{O} of an optical element O that has been molded, the side surface thickness T_{O} being a thickness of the optical element O at its side surface. That is, when viewed in the horizontal direction as illustrated in FIG. 9, the clearance Cl set such that a part of the optical element O is positioned above the opening rim 233 of the hole portion 231 of the side mold 23. Details of the method of molding an optical element O according to the third embodiment will be described below.

In this method of molding an optical element O according to the third embodiment, similarly to the first embodiment: the mold 20 that has been assembled outside the molding apparatus 1 and before molding is supplied to the mold supply unit 11 of the molding apparatus 1; an oxygen ejecting process, a heating process, a press molding process, and a cooling process are performed; and a demolding process is thereafter performed outside the molding apparatus 1. The heating process, the press molding process, the cooling process, and the demolding process are similar to those according to the first embodiment and description thereof will thus be omitted.

In the oxygen ejecting process according to the third embodiment, as illustrated in FIG. 9, oxygen is ejected and replaced with inert gas, in a state where a gap G between the outer peripheral rim 223 of the neck portion 221 of the lower mold 22 and the opening rim 233 of the hole portion 231 of the side mold 23 is smaller than the side surface thickness T_{O} of the optical element O that has been molded when the outer peripheral rim 223 of the neck portion 221 of the lower mold 22 is positioned at the first position lower than the opening rim 233 of the hole portion 231 of the side mold 23.

Furthermore, the state, in which the gap G between the outer peripheral rim 223 of the neck portion 221 of the lower mold 22 and the opening rim 233 of the hole portion 231 of the side mold 23 is smaller than the side surface thickness T_{O} of the optical element O that has been molded, is maintained from the end of the press molding process until the optical element O that has been molded is taken out in the demolding process.

According to the method of molding an optical element O as described above, the gap between the outer peripheral rim 223 of the neck portion 221 of the lower mold 22 and the opening rim 233 of the hole portion 231 of the side mold 23 is made smaller than the side surface thickness T_{O} of the optical element O that has been molded. Therefore, the optical element O is able to be prevented from falling off the lower surface molding surface 222 due to minute vibration generated when, for example the mold 20 is conveyed after press molding or the lower mold 22 is lowered after press molding. As a result, for example, the risk of performing a push-out operation (see FIG. 5) using the lower mold 22 in a state where the optical element O is not on the lower surface molding surface 222 or in a state where the optical element O juts out from the lower surface molding surface 222 and thereby damaging the mold 20 is able to be avoided in the demolding process.

For example, according to the above described demolding process in the method of molding an optical element O, the upper mold 21 is removed from the mold 20 and an optical element O is taken out by lifting the lower mold 22 using the pressing mechanism 133, but the side mold 23, in addition to the upper mold 21, may be removed from the mold 20 and the optical element O may be directly taken out from the lower mold 22 without using the pressing mechanism 133.

Additional advantages and modifications will readily occur to those skilled in the art. Therefore, the disclosure in its broader aspects is not limited to the specific details and representative embodiments shown and described herein. Accordingly, various modifications may be made without departing from the spirit or scope of the general concept as defined by the appended claims and their equivalents.

What is claimed is:

1. A method of molding an optical element, the method comprising:
preparing a molding material;
preparing: an upper mold having an upper surface molding surface provided on an end portion of a neck portion of the upper mold; a lower mold having a lower surface molding surface provided on an end portion of a neck portion of the lower mold; and a side mold having a side surface molding surface provided on an inner surface of a hole portion of the side mold;
inserting the neck portion provided in the upper mold and the neck portion provided in the lower mold into the hole portion provided in the side mold;
positioning a distal end of the neck portion of the lower mold below an opening rim of the hole portion of the side mold, and ejecting oxygen that is in the molds through a gap formed between the opening rim of the hole portion of the side mold and the molding material that has been placed on the lower surface molding surface;
heating up the molding material; and
press molding the molding material by bringing the upper mold and side mold, and the lower mold, closer to each other.

2. The method according to claim 1, further comprising taking out the optical element by lifting the lower mold after removing the upper mold from the side mold, to jut out a part of the optical element from an upper end portion of the side mold.

3. The method according to claim 1, wherein in the ejecting the oxygen, a gap between the distal end of the neck portion of the lower mold and the opening rim of the hole portion of the side mold when the distal end of the neck portion of the lower mold is positioned below the opening rim of the hole portion of the side mold, is smaller than a thickness of the molding material that has been placed on the lower surface molding surface.

4. The method according to claim 3, wherein the gap is maintained smaller than the thickness of the molding material that has been placed on the lower surface molding surface, from the placement of the molding material on the lower surface molding surface until the press molding is started.

5. The method according to claim 1, wherein in the ejecting the oxygen, a gap between the distal end of the neck portion of the lower mold and the opening rim of the hole portion of the side mold when the distal end of the neck portion of the lower mold is positioned below the opening of the hole portion of the side mold, is smaller than a side surface thickness of the optical element.

6. The method according to claim 5, wherein the gap is maintained smaller than the side surface thickness of the optical element, from end of the press molding until the optical element is taken out.

7. An optical element molding mold comprising:
an upper mold having a neck portion;
a lower mold having a neck portion;
a side mold having, provided therein, a hole portion where the neck portions of the upper mold and the lower mold are inserted;
an upper surface molding surface provided on an end portion of the neck portion of the upper mold;
a lower surface molding surface provided on an end portion of the neck portion of the lower mold; and
a side surface molding surface provided on an inner surface of the hole portion of the side mold, wherein at a first position where a gap between a distal end of the neck portion of the lower mold and an opening rim of the side mold becomes the largest, before or after a molding operation in a state where the optical element molding mold has been fitted in a molding machine, the gap is smaller than a thickness of a molding material that has been placed on the lower surface molding surface.

8. The optical element molding mold according to claim 7, wherein a length of the neck portion of the lower mold is equal to or larger than the hole portion of the side mold.

9. An optical element molding mold comprising:
an upper mold having a neck portion;
a lower mold having a neck portion;
a side mold having, provided therein, a hole portion where the neck portions of the upper mold and the lower mold are inserted;
an upper surface molding surface provided on an end portion of the neck portion of the upper mold;
a lower surface molding surface provided on an end portion of the neck portion of the lower mold; and
a side surface molding surface provided on an inner surface of the hole portion of the side mold, wherein
at a first position where a gap between a distal end of the neck portion of the lower mold and an opening rim of the side mold becomes the largest, before or after a molding operation in a state where the optical element molding mold has been fitted in a molding machine, the gap is smaller than a side surface thickness of an optical element.

10. The optical element molding mold according to claim 9, wherein a length of the neck portion of the lower mold is equal to or larger than the hole portion of the side mold.
